(19) United States
(12) Patent Application Publication
(10) Pub. No.: US 2012/0316800 A1
(43) Pub. Date: Dec. 13, 2012

(54) SYSTEM FOR PREDICTING VEHICLE VIBRATION OR ACOUSTIC RESPONSE

(76) Inventors: Gregory David Shteinhauz, Akron, OH (US); Yiu Wah Luk, Hudson, OH (US); Christophe Francois Edmond Thiry, Vielsalm (BE)

(21) Appl. No.: 13/154,816

(22) Filed: Jun. 7, 2011

(51) Int. Cl. G06F 19/00; G01M 17/02

(52) U.S. Cl. 702/56

(57) ABSTRACT

A system for predicting vibration or acoustic responses of a vehicle to a predetermined excitation of a candidate tire of the vehicle includes a first accelerometer for measuring tire responses at a test rig to the predetermined excitation of a reference tire mounted on the rig, a second accelerometer, microphone, or other vibration or acoustic sensor for measuring vibration and acoustic responses at a location on the vehicle to the predetermined excitation of the reference tire mounted on the vehicle, and a computer for calculating transfer functions as a ratio of the vibration or acoustic responses from the second accelerometer, microphone, or other vibration or acoustic sensor divided by the tire responses from the first accelerometer. The computer predicts candidate tire responses, similar to the tire responses of the first accelerometer, of the reference tire mounted on the test rig. The computer predicts vehicle vibration or acoustic responses, similar to the vibration responses of the second accelerometer, of the candidate tire mounted on the vehicle by multiplying the predicted candidate tire responses by the transfer functions.

### TECHNICAL FIELD

A system in accordance with the present invention predicts vehicle vibration or acoustic responses to road imperfections and, more specifically, utilizes both vehicle data and tire/wheel data from a test rig, or a computer simulation, for predicting the vehicle vibration or acoustic responses (e.g., related to passengers comfort).

### SUMMARY OF THE INVENTION

A system in accordance with the present invention for predicting vibration or acoustic responses of a vehicle to a predetermined excitation of a candidate tire of the vehicle includes a first accelerometer for measuring tire responses at a test rig to the predetermined excitation of a reference tire mounted on the rig, a second accelerometer, microphone, or other vibration or acoustic sensor for measuring vibration and acoustic responses at a location on the vehicle to the predetermined excitation of the reference tire mounted on the vehicle, and a computer for calculating transfer functions as a ratio of the vibration or acoustic responses from the second accelerometer, microphone, or other vibration or acoustic sensor divided by the tire responses from the first accelerometer. The computer predicts candidate tire responses, similar to the tire responses of the first accelerometer, of the reference tire mounted on the test rig. The computer predicts vehicle vibration or acoustic responses, similar to the vibration responses of the second accelerometer, of the candidate tire mounted on the vehicle by multiplying the predicted candidate tire responses by the transfer functions.

According to another aspect of the present invention, the predetermined excitation is defined by a cleat fixed to a rotating drum.

According to still another aspect of the present invention, the computer compares the predicted vehicle vibration responses to the predetermined excitation of the candidate tire to expected vibration responses to the predetermined excitation of the candidate tire.

According to yet another aspect of the present invention, the system further includes suspension parameters for predicting vibration responses of the reference tire on the test rig tire such that suspended test rig vibration responses equal vibration responses of the reference tire measured on the vehicle.

According to still another aspect of the present invention, the system further includes a third accelerometer for measuring vibration responses at a second location on the vehicle to the predetermined excitation of the reference tire mounted on the vehicle.

According to yet another aspect of the present invention, the computer calculates transfer functions as a ratio of the vibration responses from the third accelerometer divided by the tire responses from the first accelerometer.

In accordance with the present invention, a method for predicting vibration response of a vehicle to a predetermined excitation of a candidate tire of the vehicle comprises the steps of: measuring or predicting tire responses at a test rig to a predetermined excitation of a reference tire mounted on the test rig; measuring vibration or acoustic responses at a location on the vehicle to the predetermined excitation of the reference tire mounted on the vehicle; calculating transfer functions as a ratio of the vibration or acoustic responses on the vehicle divided by the tire vibration responses on the rig; predicting vibration responses of the candidate tire mounted on the test rig; and predicting vehicle vibration or acoustic responses for the candidate tire mounted on the vehicle by multiplying the predicted vibration responses by the transfer functions.

According to another aspect of the present invention, the predetermined excitation is defined by a cleat fixed to a rotating drum.

According to still another aspect of the present invention, the method further includes the step of comparing the predicted vehicle vibration responses to the predetermined excitation of the candidate tire to expected vibration responses to the predetermined excitation of the candidate tire.

According to yet another aspect of the present invention, the method further includes suspension parameters for predicting vibration responses of the reference tire on the test rig tire such that suspended test rig vibration responses equal vibration responses of the reference tire measured on the vehicle.

According to still another aspect of the present invention, the method further includes the step of measuring vibration responses at a second location on the vehicle to the predetermined excitation of the reference tire mounted on the vehicle.

According to yet another aspect of the present invention, the method further includes the step of calculating transfer functions as a ratio of the vibration responses from the second location divided by the measured responses of the reference tire on the rig.

According to still another aspect of the present invention, the measured vibration responses on the test rig and vibration responses on the vehicle include a fore/aft component, a lateral component, and a vertical component.

According to yet another aspect of the present invention, the predicted acceleration or vibration of the candidate tire and vibration responses of the vehicle include a fore/aft component, a lateral component, and a vertical component.

According to still another aspect of the present invention, the method further includes the step of measuring vibration responses at second and third locations on the vehicle to the predetermined excitation of the reference tire mounted on the vehicle.

According to yet another aspect of the present invention, the method further includes the step of predicting vibration responses at second and third locations on the vehicle to the predetermined excitation of the candidate tire mounted on the vehicle.

According to still another aspect of the present invention, the measured vibration responses of the reference tire include a fore/aft component, a lateral component, and a vertical component.

According to yet another aspect of the present invention, the predicted vibration responses of the candidate tire include a fore/aft component, a lateral component, and a vertical component.

In accordance with the present invention, another method for predicting vibration response of a vehicle to a predetermined excitation of a candidate tire on the vehicle includes the steps of: measuring or predicting tire responses at a spindle of a vehicle to the predetermined excitation of a reference tire mounted on the vehicle; measuring vibration or acoustic responses at a location on the vehicle to the predetermined excitation of the reference tire mounted on the vehicle; calculating transmissibility functions as a ratio of the vibration or acoustic responses of the vehicle divided by the tire responses measured or predicted on the spindle of the vehicle; predicting spindle vibrations of the candidate tire mounted on the spindle; and predicting vehicle vibration or acoustic responses for the candidate tire mounted on the vehicle by multiplying the predicted spindle vibration responses by the transmissibility functions.

According to another aspect of the present invention, the method further includes the step of measuring vibration or acoustic responses at a second location of the vehicle to the predetermined excitation of the reference tire mounted on the vehicle.

Other aspects, features and advantages of the invention will become apparent in light of the following example description thereof.

### BRIEF DESCRIPTION OF THE DRAWINGS

Reference will be made in detail to example embodiments of the present invention, which are illustrated in the accompanying figures. The figures are intended to be illustrative, not limiting. Although the present invention is generally described in the context of these example embodiments, it should be understood that example embodiments are not intended to limit the spirit and scope of the present invention to these example embodiments.

FIG. 1 is a schematic view of a testing system for determining vibration response within a vehicle.

FIG. 2 is a schematic view of a testing system, or fixed spindle rig, for determining vibration response of a tire/wheel system.

FIG. 3 is a schematic representation of part of a system in accordance with the present invention.

FIG. 4 is a schematic representation of another part of a system in accordance with the present invention.

FIG. 5 is a schematic graph of Fore/Aft Forces versus Frequency of six example tires generated at a fixed spindle rig, such as that of FIG. 2.

FIG. 6 is a schematic graph of Vertical Forces versus Frequency of six example tires generated at a fixed spindle rig, such as that of FIG. 2.

FIG. 7 is a schematic graph of the Fore/Aft Vehicle Acceleration Response Spectra at the Left Front Wheel of the Vehicle.

FIG. 8 is a schematic graph of the Vertical Vehicle Acceleration Response Spectra at the Left Front Wheel of the Vehicle.

FIG. 9 is a schematic graph of the Fore/Aft Vehicle Acceleration Response Spectra at the Steering Wheel of the Vehicle.

FIG. 10 is a schematic graph of the Lateral Vehicle Acceleration Response Spectra at the Steering Wheel of the Vehicle.

FIG. 11 is a schematic graph of the Vertical Vehicle Acceleration Response Spectra at the Steering Wheel of the Vehicle.

FIG. 12 is a schematic graph of the Fore/Aft Transfer Functions at the Left Front Wheel of the Vehicle.

FIG. 13 is a schematic graph of the Vertical Transfer Functions at the Left Front Wheel of the Vehicle.

FIG. 14 is a schematic graph of the predicted Fore/Aft Left Front Wheel Responses and the measured Fore/Aft Left Front Wheel Responses.

FIG. 15 is a schematic graph of the predicted Vertical Left Front Wheel Responses and the measured Vertical Left Front Wheel Responses.

FIG. 16 is a schematic graph of the predicted Fore/Aft Right Front Wheel Responses and the measured Fore/Aft Right Front Wheel Responses.

FIG. 17 is a schematic graph of the predicted Vertical Right Front Wheel Responses and the measured Vertical Right Front Wheel Responses.

FIG. 18 is a schematic graph of the predicted Fore/Aft Steering Wheel Responses and the measured Fore/Aft Steering Wheel Responses.

FIG. 19 is a schematic graph of the predicted Lateral Steering Wheel Responses and the measured Lateral Steering Wheel Responses.

FIG. 20 is a schematic graph of the predicted Vertical Steering Wheel Responses and the measured Vertical Steering Wheel Responses.

FIG. 21 is a schematic graph of the predicted Fore/Aft Seat Track Responses and the measured Fore/Aft Seat Track Responses.

FIG. 22 is a schematic graph of the predicted Lateral Seat Track Responses and the measured Lateral Seat Track Responses.

FIG. 23 is a schematic graph of the predicted Vertical Seat Track Responses and the measured Vertical Seat Track Responses.

FIG. 24 is a schematic graph of the predicted Vertical Floor Responses and the measured Vertical Floor Responses.

FIG. 25 is a schematic table of predicted and measured Spectral Band Energies at the Left Front Wheel of the Vehicle in the Vertical Direction for six different example tire constructions.

### DEFINITIONS

“Axial” and “axially” are used herein to refer to lines or directions that are parallel to the axis of rotation of the tire.

“Energy Spectral Density” means a positive real function of a frequency associated with a transient dynamic process or a deterministic transient function of time, obtained by Fourier Transform, and subsequent squaring and of magnitudes and scaling, and has dimensions of amplitude²*sec/Hz.

“Force response” means forces or moments measured or predicted in a moving system (for example, a vehicle, or a tire-wheel system, or a test rig) due to road or test drum excitation).

“Pneumatic tire” means a laminated mechanical device of generally toroidal shape (usually an open torus) having beads and a tread and made of rubber, chemicals, fabric and steel or other materials. When mounted on the wheel of a motor vehicle, the tire through its tread provides traction and contains the fluid or gaseous matter, usually air, that sustains the vehicle load.

“Radial” and “radially” are used to mean directions radially toward or away from the axis of rotation of the tire.

“Spectral Band Energy” means the area under a curve of Energy Spectral Density for a specified frequency range of interest.

“Transfer Function” means a mathematical representation of the relation between the input and output of a linear time-invariant system. The input and output of a Transfer Function may be physically different signals, i.e. Acceleration/Force, Velocity/Force, Displacement/Force, Force/Acceleration, etc. A Transfer Function may be calculated as a function of complex variable using a Laplace Transform. A special case of a Transfer Function may be a function of frequency only, called “Frequency Response Function”.

“Transmissibility Function” means a mathematical representation of the relation between the input and output of a linear time-invariant system. The input and output of a Transmissibility Function may be physically similar signals, i.e. Acceleration/Acceleration, Force/Force, etc. A Transmissibility Function may be calculated as a function of complex variable using a Laplace Transform. A special case of a Transmissibility Function may be a function of frequency only, called “Frequency Response Transmissibility Function”.

“Vibration response” means mechanical vibrations or oscillations by a moving system (for example, a vehicle, or a tire-wheel system, or a test rig) due to road or test drum excitation. Vibration response may be described and measured in the form of acceleration, velocity or displacement.

### DESCRIPTION OF EXAMPLE EMBODIMENTS OF THE PRESENT INVENTION

The present invention provides a system for predicting vehicle vibration or acoustic responses to cleat excitation for a specific tire, existing (e.g., a physically available tire) or non-existing (e.g., a candidate or prototype tire). The system may be defined in terms of an assembly, a method, an apparatus, and/or parts of any of these three. A system in accordance with the present invention may utilize results of two lab tests: (1) cleat testing of an instrumented vehicle on chassis roll; and (2) cleat testing of tires/wheels on a test rig. A combined analysis of both groups of test data may thereby provide vehicle transfer functions for predicting the vehicle responses using candidate tires, which may or may not be physically available. Thus, this data may subsequently be used to support tire development for a target vehicle. The system may be based on two testing procedures and may employ realistic levels of tire/wheel and vehicle excitation. The system considers both tire/wheel and vehicle dynamics and their inevitable interaction to predict total vibration or acoustic responses of tire/wheel-vehicle assemblies/systems.

The system of the present invention may include cleat testing of an instrumented vehicle to ascertain the vehicle's vibration responses for different tire/wheel constructions, test rig testing of the same tire/wheel constructions under the same test conditions to ascertain the test rig's vibration responses, spectrum analysis of the vehicle and test rig data, populating input and output matrices for all measured vibration data, calculating transfer functions for the multi-input-multi-output system utilizing a least square error minimization or other suitable technique, and utilizing the calculated transfer functions and the input vibration data from candidate tires to predict vehicle vibration or acoustic responses. The system may thus predict vehicle vibration or acoustic responses for tire constructions, including vehicle dynamics, to improve the ability to select the tire constructions and speed up tire development, particularly for ride comfort.

The system may utilize a conventional tire/wheel/vehicle lab test with rolling tires on a drum, excited by a cleat of a realistic size, reflecting a true vehicle excitation and the conventional test rig test of the tires/wheels on the same drum with the same cleat, same inflation, and same load and test speed to obtain accelerations and/or forces and moments developed by the tire/wheel construction. However, the system advantageously utilizes the results of the two tests to calculate transfer functions that also relate the multiple input forces to vibration or acoustic responses of the vehicle (e.g., multi-input-single-output system identification). The system may thereby apply the calculated transfer functions to a candidate tire construction using measured and/or predicted test rig vibration. The predicted results for examples of the system of the present invention are shown below to be quite similar to the measured results.

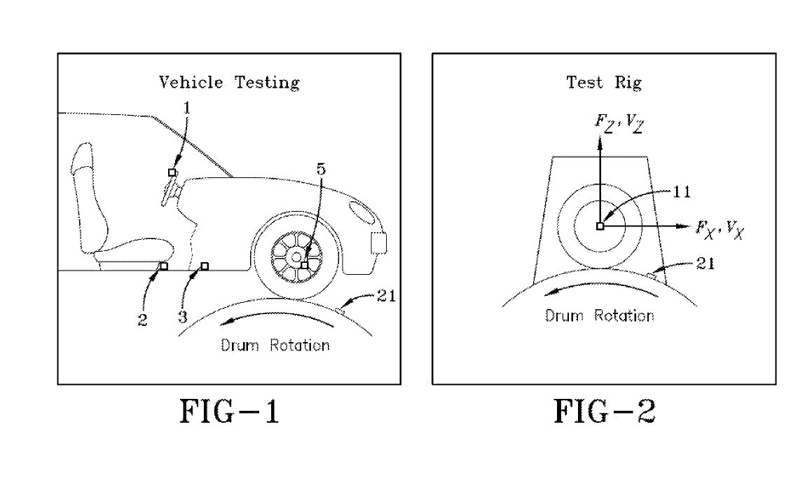

Referring now to the drawings, which are for the purpose of illustrating example embodiments of the present invention only, and not for purposes of limiting the present invention. FIG. 1 is a schematic view of a testing system for determining vibration response within a vehicle. Sensors, or accelerometers, may be mounted to the steering wheel 1, the seat track 2, the vehicle floor 3, the left front wheel 11 (not shown), and the right front wheel 5. As shown, the cleat 21 (by rotation of the drum or translation of a horizontal surface) may excite the front right wheel in order to determine vibration response at the accelerometers 1, 2, 3, 4, and 5. FIG. 2 is a schematic view of a testing system, or locked/fixed spindle test rig, for determining vibration response of a tire/wheel assembly. As shown, the cleat 21 (by rotation of the drum or translation of the horizontal surface) may excite the tire/wheel in order to determine vibration response at the sensors 5, 11 on the spindle of the rig.

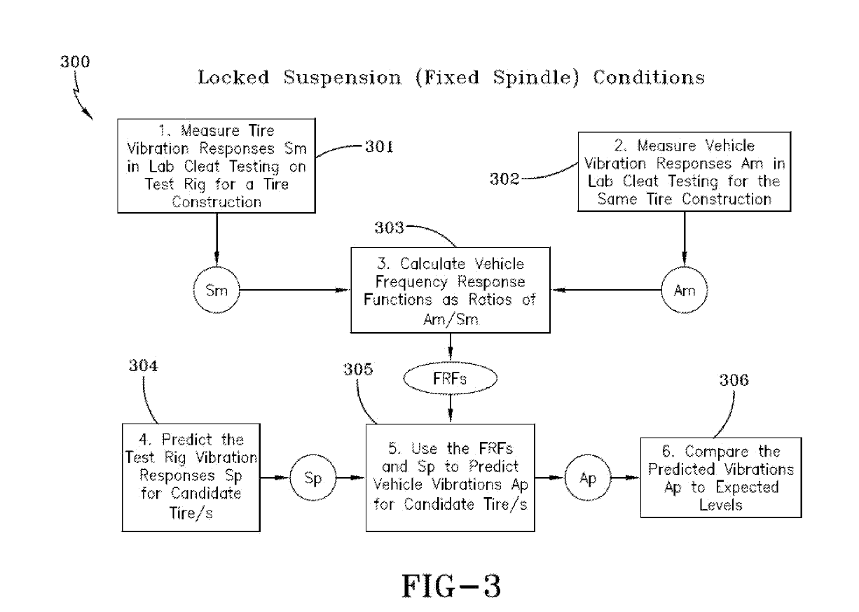

FIG. 3 is a schematic representation of part of a system 300 in accordance with the present invention. In step 301, vibration responses Sₘ to lab cleat testing of a specific tire/wheel construction may be measured or predicted on a test rig, as in FIG. 2. In step 302, vehicle vibration or acoustic responses Aₘ may be measured, such as by accelerometers 1, 2, and 3, to lab cleat testing of a specific vehicle with the specific tire/wheel construction excited by the cleat 21, as in FIG. 1. In step 303, vehicle frequency response functions FRF, or Transfer Functions, may be calculated, such as by a computer or microprocessor, as ratios of the vehicle vibration responses from step 302 divided by the vibration responses from step 301 (Aₘ/Sₘ). In step 304, test rig vibration Sₚ may be predicted by conventional methods for candidate, or untested, tire/wheel constructions. In step 305, vehicle vibration or acoustic responses Aₚ to the candidate tire/wheel constructions may be predicted by multiplying the predicted test rig vibration Sₚ from step 304 by the transfer functions from step 303. In step 306, the vehicle vibration or acoustic responses Aₚ may be compared to expected levels.

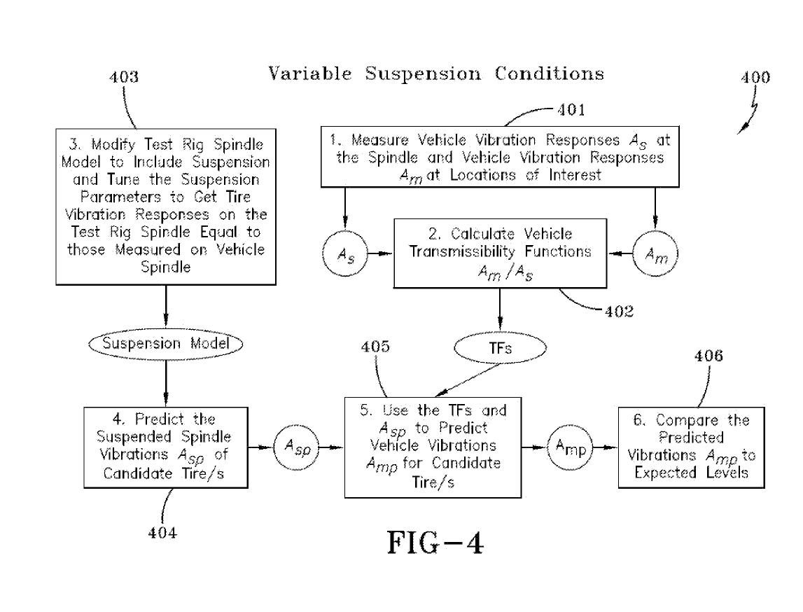

FIG. 4 is a schematic representation of part of a system 400 in accordance with the present invention. In step 401, vehicle spindle vibration responses Aₛ may be measured, such as by accelerometer 4 and/or 5, to lab cleat testing of a specific tire/wheel construction, as in FIG. 1, and vehicle vibration or acoustic responses Aₘ may be measured, such as by accelerometers or microphones 1, 2, and 3, to lab cleat testing of a specific tire/wheel construction at locations of interest on the vehicle, as in FIG. 1. In step 402, vehicle transmissibility functions TF may be calculated as ratios of the vehicle vibration or acoustic responses from step 401 divided by the vehicle spindle vibration responses from step 401 (Aₘ/Aₛ). In step 403, the conventional fixed test rig may be modified by adding a variable suspension for replicating the actual vehicle spindle response. The parameters of the suspension components may be tuned to reproduce on the rig spindle the vibration responses of the vehicle spindle measured on the vehicle spindle for the same tire/wheel construction and excitation (e.g., “tuning” the modeled suspension). In step 404, test rig spindle vibrations Aₛₚ may be predicted for a candidate tire/wheel construction. In step 405, the vehicle vibration or acoustic responses Aₘₚ for candidate tire/wheel constructions may be predicted by utilizing the transmissibility functions TF from step 402 and the test rig spindle vibrations Aₛₚ from step 404. In step 406, the vehicle vibration or acoustic responses Aₘₚ may be compared to expected levels.

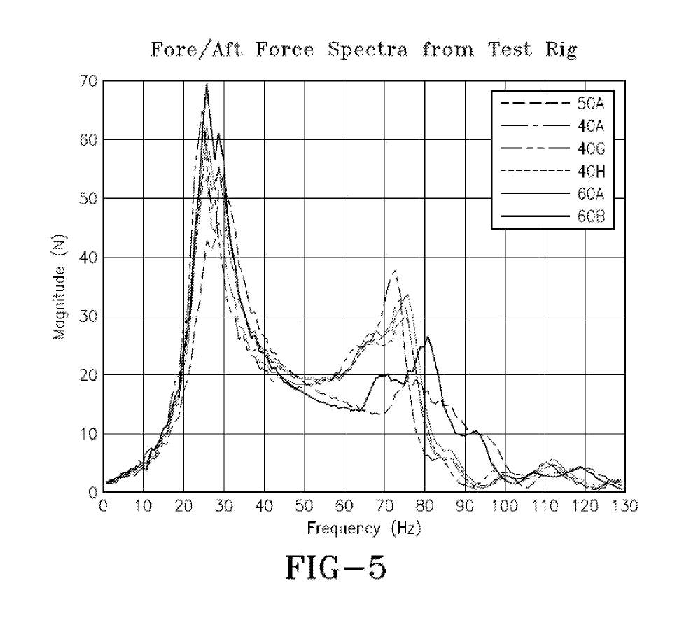

FIG. 5 is a schematic graph of Fore/Aft Forces versus Excitation Frequency of six example tire/wheel constructions measured at a test rig, such as that of FIG. 2. The tested tire/wheel constructions vary significantly in magnitude in the frequency range of 0 to 40 hz and in magnitude and frequency between 40 and 130 hz.

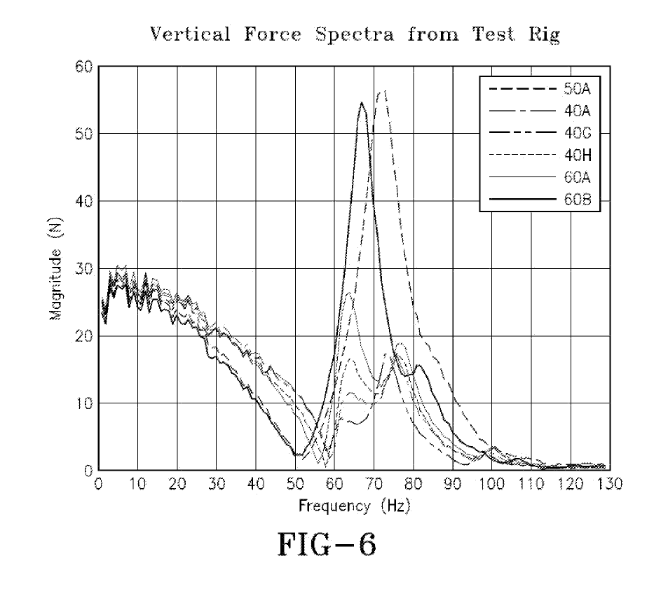

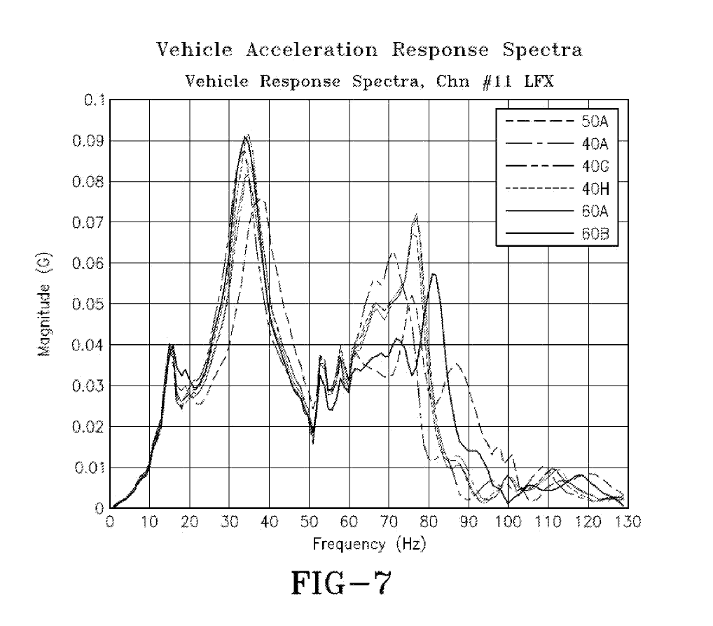

FIG. 6 is a schematic graph of Vertical Forces versus Excitation Frequency of six example tire/wheel constructions measured at a test rig, such as that of FIG. 2. The tested tire/wheel constructions vary significantly in magnitude and frequency in the frequency range of 50 to 110 hz.

FIG. 7 is a schematic graph of Fore/Aft Vehicle Acceleration Response Spectra versus Excitation Frequency of six example tire/wheel constructions measured at vehicle's spindle, such as that of FIG. 1. The dominant modes of vehicle vibration response occupy the same frequency ranges as tire/wheel force modes on the test rig.

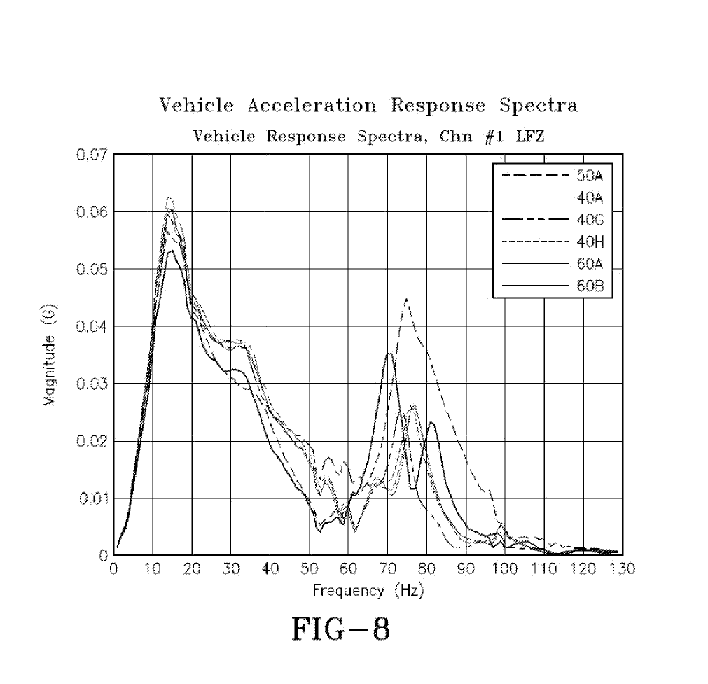

FIG. 8 is a schematic graph of the Vertical Vehicle Acceleration Response Spectra versus Excitation Frequency of six example tire/wheel constructions measured at vehicle's spindle, such as that of FIG. 1. Again, the dominant modes of vehicle vibration response occupy the same excitation frequency ranges as tire/wheel force modes on the test rig.

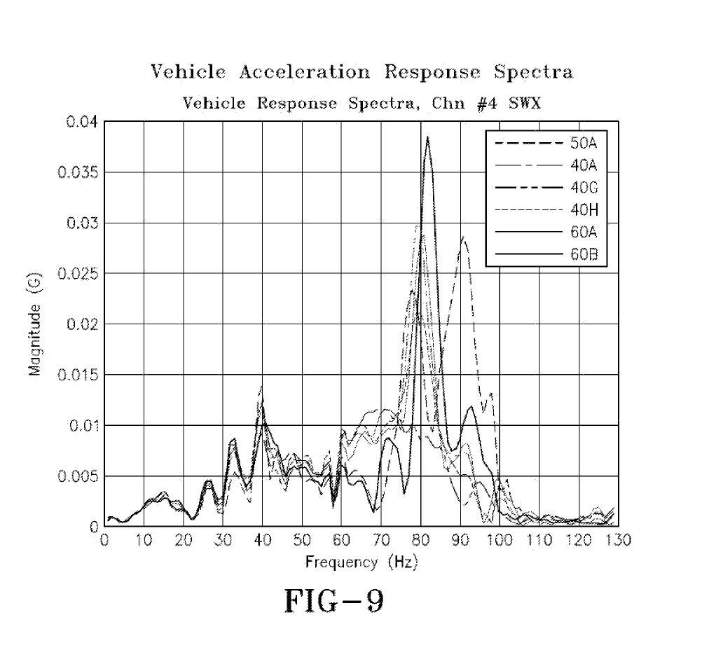

FIG. 9 is a schematic graph of the Fore/Aft Vehicle Acceleration Response Spectra at the Steering Wheel of the Vehicle versus Excitation Frequency of six example tire/wheel constructions measured at vehicle's spindle, such as that of FIG. 1. Again, the dominant modes of vehicle vibration response occupy the same excitation frequency ranges as tire/wheel force modes on the test rig.

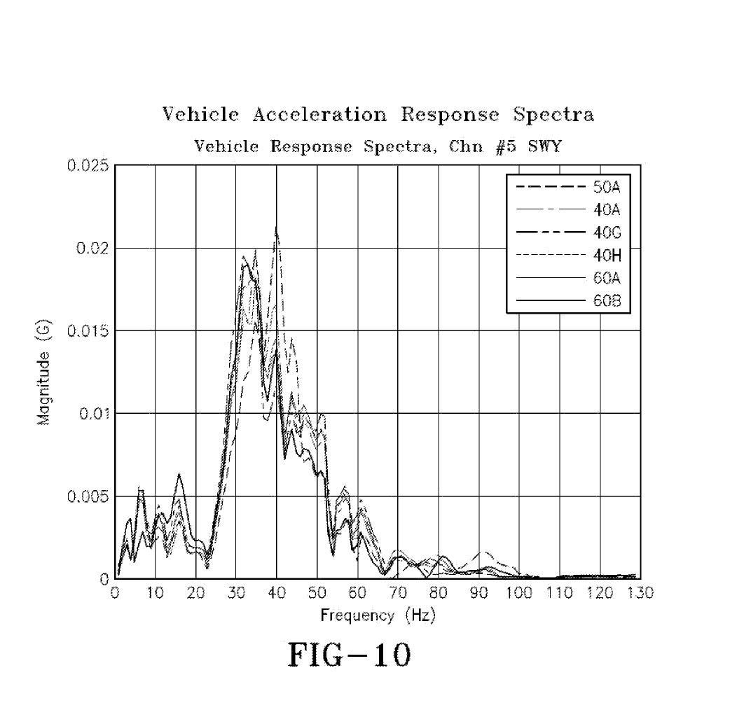

FIG. 10 is a schematic graph of the Lateral Vehicle Acceleration Response Spectra at the Steering Wheel of the Vehicle versus Excitation Frequency of six example tire/wheel constructions measured at vehicle's spindle, such as that of FIG. 1. Again, the dominant modes of vehicle vibration response occupy the same excitation frequency ranges as tire/wheel force modes on the test rig.

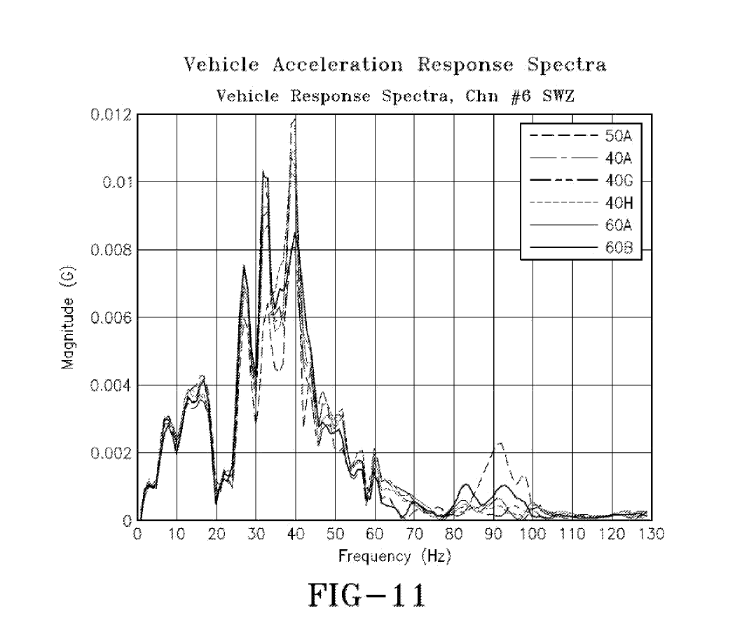

FIG. 11 is a schematic graph of the Vertical Vehicle Acceleration Response Spectra at the Steering Wheel of the Vehicle versus Excitation Frequency of six example tire/wheel constructions measured at vehicle's spindle, such as that of FIG. 1. Again, the dominant modes of vehicle vibration response occupy the same excitation frequency ranges as tire/wheel force modes on the test rig.

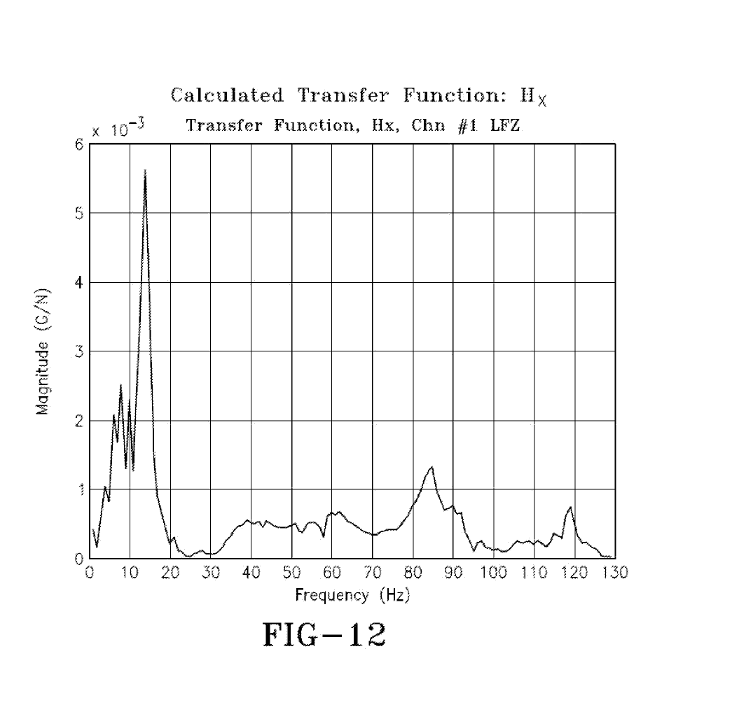

FIG. 12 is a schematic graph of the Transfer Functions between the Fore/Aft Force measured at the test rig such as that of FIG. 2, and Fore/Aft Acceleration measured on vehicle's spindle, as that of FIG. 1. The Acceleration was measured at the Left Front Wheel Spindle.

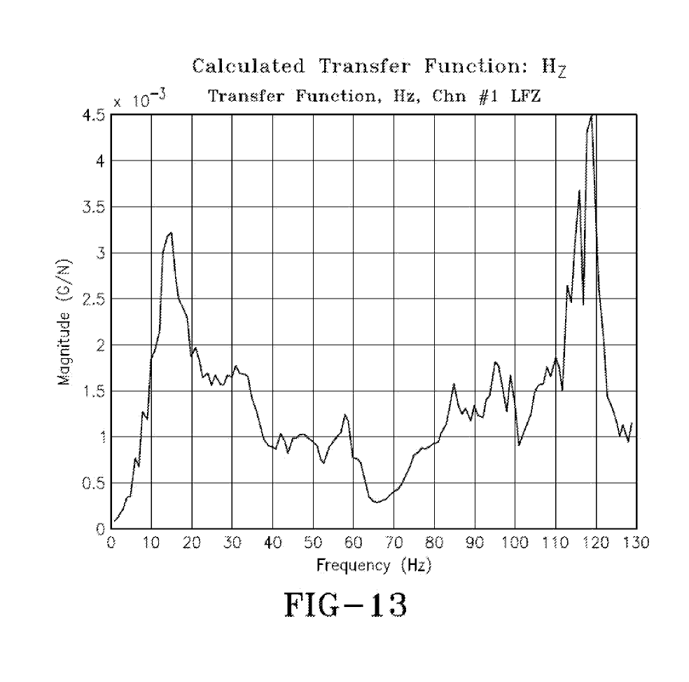

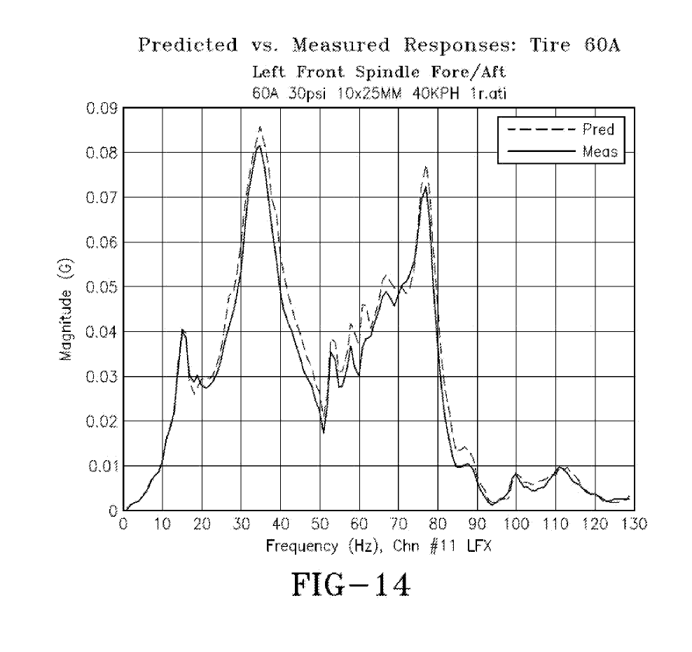

FIG. 13 is a schematic graph of the Transfer Functions between the Vertical Force measured at the test rig such as that of FIG. 2, and Vertical Acceleration measured on vehicle's spindle, as that of FIG. 1. The Acceleration was measured at the Left Front Wheel Spindle.

FIG. 14 is a schematic graph of the predicted Fore/Aft Left Front Wheel Spindle Acceleration Responses and the measured Fore/Aft Left Front Wheel Spindle Acceleration Responses versus Excitation Frequency measured at the Left Front Wheel Spindle of the Vehicle, such as that of FIG. 1. As shown, the predicted spectra are very close to the measured spectra in general pattern, magnitudes, and vibration modes.

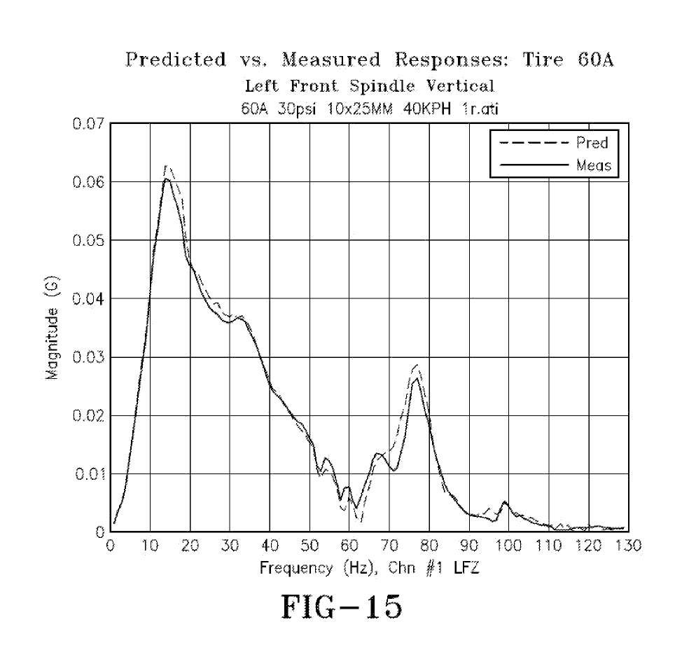

FIG. 15 is a schematic graph of the predicted Vertical Left Front Wheel Spindle Acceleration Responses and the measured Vertical Left Front Wheel Spindle Acceleration Responses versus Excitation Frequency measured at the Left Front Wheel Spindle of the Vehicle, such as that of FIG. 1. As shown, the predicted spectra are very close to the measured spectra in general pattern, magnitudes, and vibration modes.

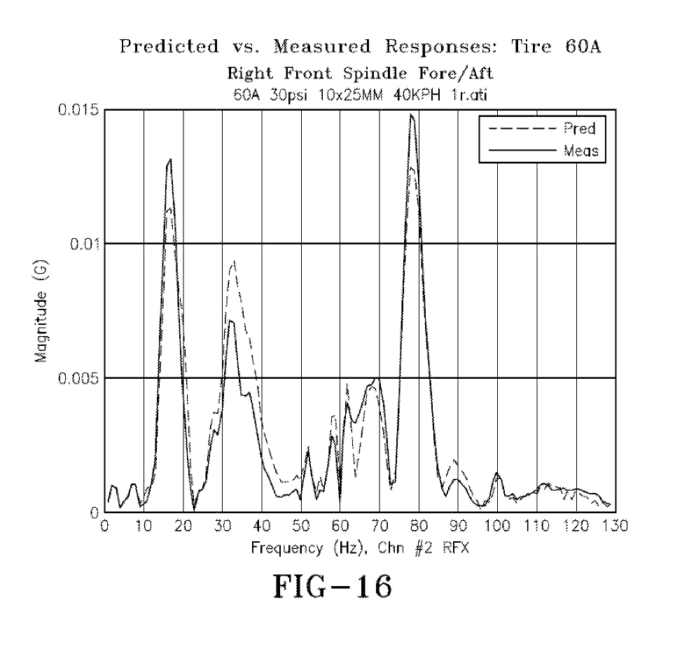

FIG. 16 is a schematic graph of the predicted Fore/Aft Right Front Wheel Spindle Acceleration Responses and the measured Fore/Aft Right Front Wheel Spindle Acceleration Responses versus Excitation Frequency measured at the Right Front Wheel Spindle of the Vehicle, such as that of FIG. 1. As shown, the predicted spectra are very close to the measured spectra in general pattern, magnitudes, and vibration modes.

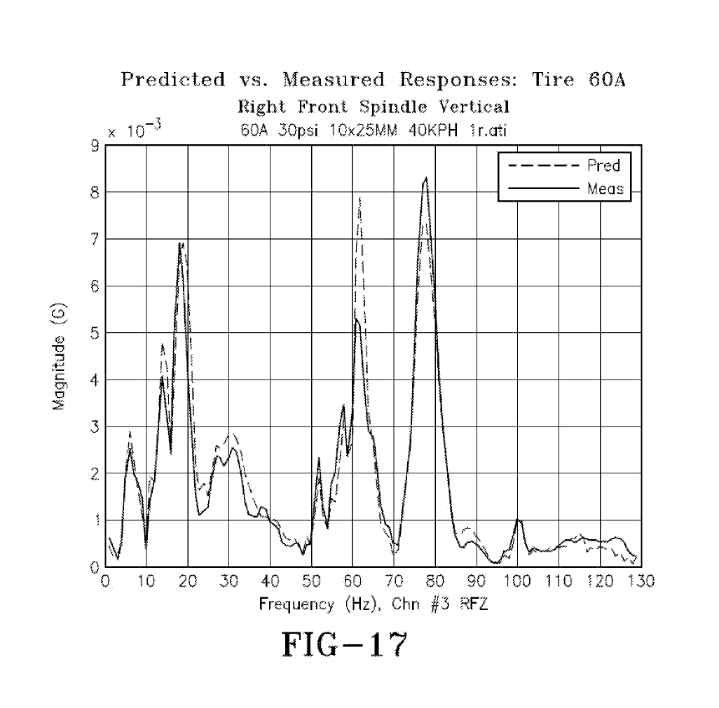

FIG. 17 is a schematic graph of the predicted Vertical Right Front Wheel Spindle Acceleration Responses and the measured Vertical Right Front Wheel Spindle Acceleration Responses versus Excitation Frequency measured at the Right Front Wheel Spindle of the Vehicle, such as that of FIG. 1. As shown, the predicted spectra are very close to the measured spectra in general pattern, magnitudes, and vibration modes.

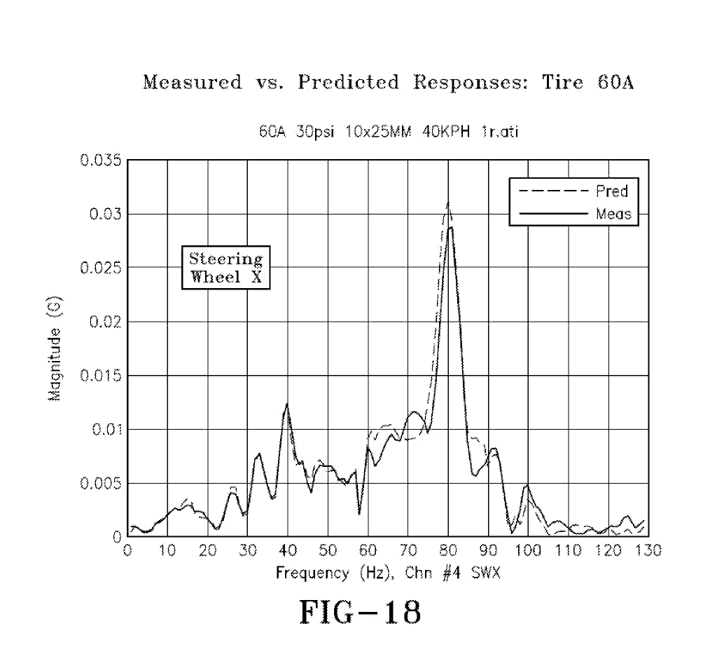

FIG. 18 is a schematic graph of the predicted Fore/Aft Steering Wheel Acceleration Responses and the measured Fore/Aft Steering Wheel Acceleration Responses versus Excitation Frequency generated at the Steering Wheel of the Vehicle, such as that of FIG. 1. As shown, the predicted spectra are very close to the measured spectra in general pattern, magnitudes, and vibration modes.

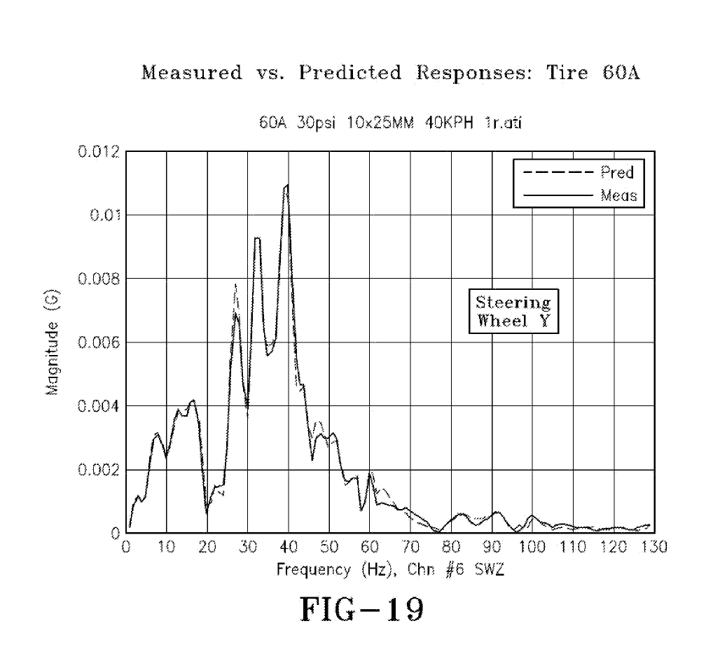

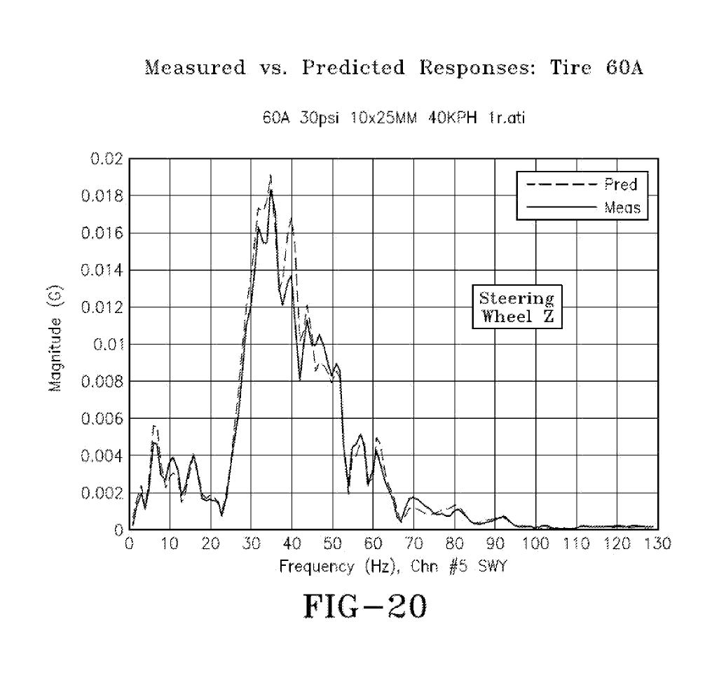

FIG. 19 is a schematic graph of the predicted Lateral Steering Wheel Acceleration Responses and the measured Lateral Steering Wheel Acceleration Responses versus Excitation Frequency generated at the Steering Wheel of the Vehicle, such as that of FIG. 1. As shown, the predicted spectra are very close to the measured spectra in general pattern, magnitudes, and vibration modes.

FIG. 20 is a schematic graph of the predicted Vertical Steering Wheel Acceleration Responses and the measured Vertical Steering Wheel Acceleration Responses versus Excitation Frequency generated at the Steering Wheel of the Vehicle, such as that of FIG. 1. As shown, the predicted spectra are very close to the measured spectra in general pattern, magnitudes, and vibration modes.

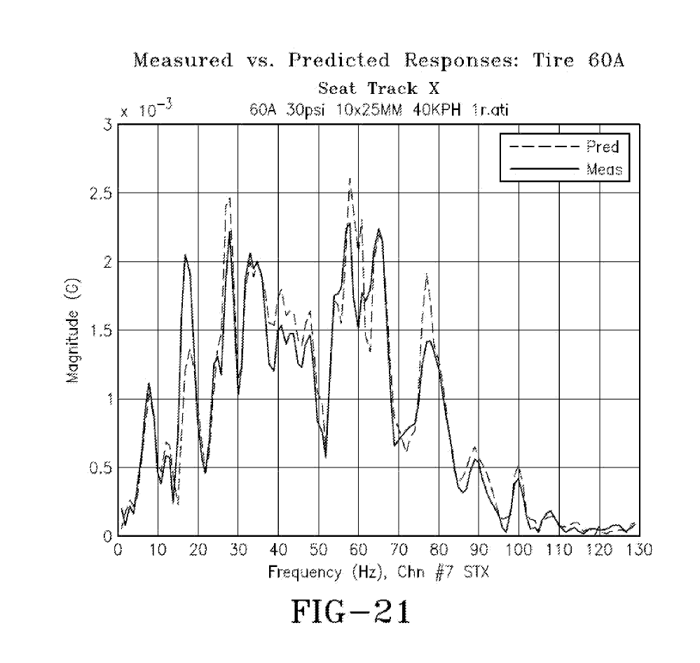

FIG. 21 is a schematic graph of the predicted Fore/Aft Seat Track Acceleration Responses and the measured Fore/Aft Seat Track Acceleration Responses versus Excitation Frequency generated at the Seat Track of the Vehicle, such as that of FIG. 1. As shown, the predicted spectra are very close to the measured spectra in general pattern, magnitudes, and vibration modes.

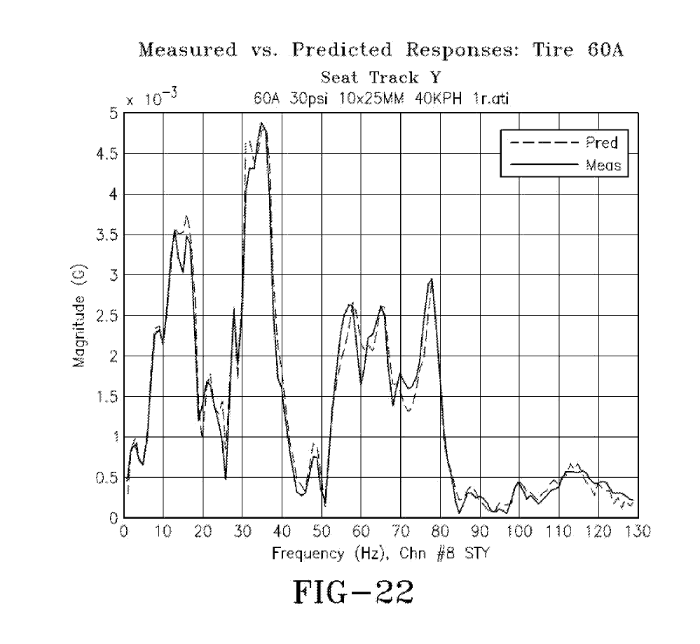

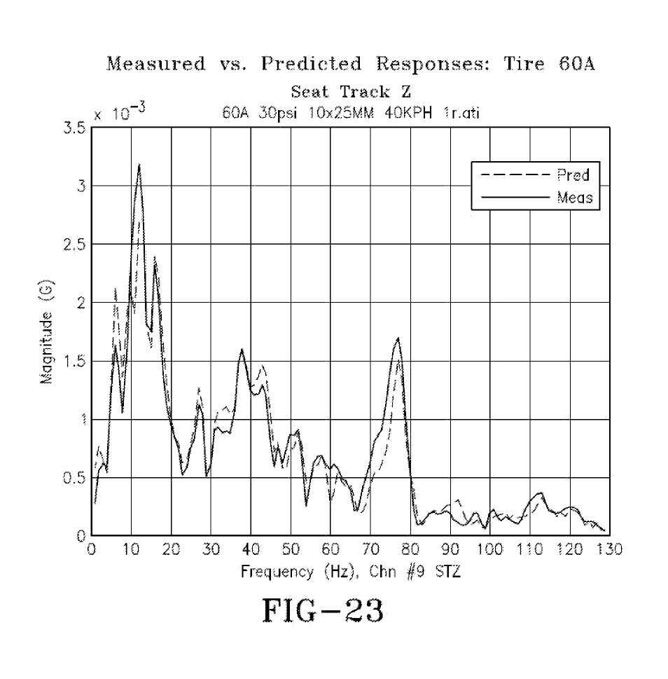

FIG. 22 is a schematic graph of the predicted Lateral Seat Track Acceleration Responses and the measured Lateral Seat Track Acceleration Responses versus Excitation Frequency generated at the Seat Track of the Vehicle, such as that of FIG. 1. As shown, the predicted spectra are very close to the measured spectra in general pattern, magnitudes, and vibration modes.

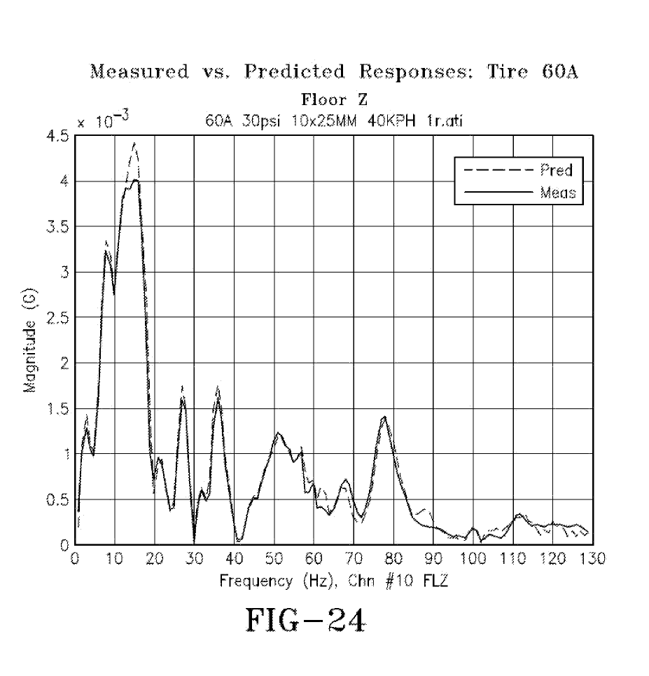

FIG. 23 is a schematic graph of the predicted Vertical Seat Track Acceleration Responses and the measured Vertical Seat Track Acceleration Responses versus Excitation Frequency generated at the Seat Track of the Vehicle, such as that of FIG. 1. As shown, the predicted spectra are very close to the measured spectra in general pattern, magnitudes, and vibration modes.

FIG. 24 is a schematic graph of the predicted Vertical Floor Acceleration Responses and the measured Vertical Floor Acceleration Responses versus Excitation Frequency generated at the Floor of the Vehicle, such as that of FIG. 1. As shown, the predicted spectra are very close to the measured spectra in general pattern, magnitudes, and vibration modes.

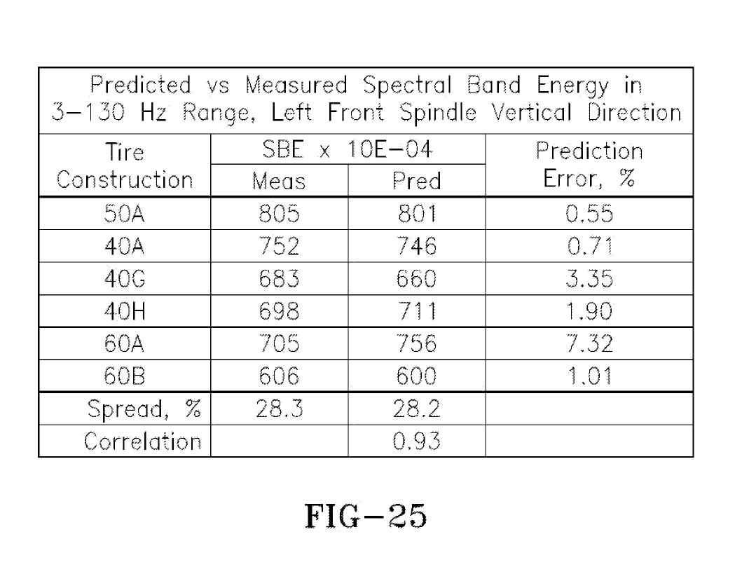

FIG. 25 is a schematic table of predicted and measured Spectral Band Energies at the Left Front Wheel of the Vehicle in the Vertical Direction for six different example tire constructions. The first four tire/wheel constructions were utilized for identifying Transfer Functions, such as those of FIGS. 13 and 14. The Vibration Responses of the fifth and sixth tire/wheel constructions were predicted utilizing the Transfer Functions. As shown, prediction errors range from 1.01 percent to 7.32 percent.

The system thus may predict vehicle vibration or acoustic responses for ride comfort rating of tires. The system may use the results of lab or road cleat testing of an instrumented vehicle on chassis roll and lab cleat testing or simulation of tires on a fixed spindle or suspension test rig. The system of the present invention may conduct a “joint” analysis of two groups of test data thereby providing vehicle transfer functions, which may be used in predicting the responses of candidate tires and their relative ranking for expected ride performance.

As an example calculation of Transfer Functions using the system 400 of FIG. 4, vibration response, measured at a vehicle location i while equipped with a tire k, due to cleat excitation of a left front corner of a vehicle, may be assumed to be:

Aₛₖ=Hₓ·Aₖₓ+H_{z}·A_{kz} (1)

Aₗₖ may be the vibration response spectrum, Hₓ and H_{z} may be Transfer Functions, specific for the vehicle location i, and Aₖₓ and A_{kz} may be spectra of the Fore/Aft and Vertical accelerations, respectively, measured/predicted on a fixed spindle test rig for the same tire k as in vehicle cleat testing.

If the Transfer Functions Hₓ and H_{z} are known, then for known or predicted fixed spindle test rig accelerations, the expected vehicle vibration response Aᵢₖ for a candidate tire k may be calculated, instead of actually tested on the vehicle or just not even physically testable. To find the Transfer Functions, the system may modify the formula (I), presenting the Transfer Functions for a given spectral line as complex numbers, as follows:

Aᵢ=(a+jb)·Aₖₓ+(c+jd)·A_{kz} (2)

j may be a square root of (−1); a, b, c, and d may be determined, while A may be measured. To determine a, b, c, and d, measurements from at least four different tires/wheels (e.g., four corners), or possibly from a single tire measured at four different pressure levels, may be obtained. More than four measurements may likely produce an improved vibration prediction.

To assess FIG. 5, test measurement data from six tires was utilized. Acceleration data of four of the six were used for determination with predictions of the two remaining tires for validation. For a given response, and multiple tires, used for the Transfer Function calculation, the matrix formula for each spectral line may be:

{A}_{n×1}={A}^{T}{H}^{T} (3)

[A] may be a matrix of fixed spindle test rig accelerations, where n is a number of tires, and {H} is a vector of Transfer Functions, to be calculated as follows:

{H}=[A]⁻¹{A} (4)

A pseudo-inverse relationship may be utilized since matrix [A] is a non-square matrix. Once calculated, the Transfer Functions may be used for predicting the acceleration responses of other two tires with known fixed spindle test rig accelerations using the formula (I).

Filling matrix [F] for a single spectral line (e.g., a point on the vibration spectrum corresponding to a 15 hz mode of a spindle test rig vertical response) may be:

$$[ A ] = [ \begin{matrix}- 6.5112 + 0.1259 i & - 10.0122 + 24.7837 i \\ - 6.8413 + 0.8065 i & - 8.5918 + 26.4857 i \\ - 7.8932 + 0.2704 i & - 9.9649 + 25.0118 i \\ - 7.5666 + 0.6688 i & - 8.7876 + 26.1350 i\end{matrix} ] \qquad ( 5 )$$

### Filling {A} may be:

$$\{ A \} = \{ \begin{matrix}0.0198 + 0.0560 i \\ 0.0274 + 0.0561 i \\ 0.0263 + 0.0500 i \\ 0.0275 + 0.0526 i\end{matrix} \} \qquad ( 6 )$$

### Pseudo-inverse of [A] may be:

$${[ A ]}^{- 1} = [ \begin{matrix}0.4512 + 0.0763 i & 0.3598 - 0.0471 i & - 0.6126 - 0.0105 i & - 0.2347 - 0.0050 i \\ - 0.0331 - 0.1258 i & - 0.0566 - 0.0998 i & 0.0595 + 0.1412 i & 0.0209 + 0.0486 i\end{matrix} ] \qquad ( 7 )$$

The Transfer Functions Vector {H} may be calculated:

$$\{ H \} = {[ A ]}^{- 1} \{ A \} = \{ \begin{matrix}- 0.0036 + 0.0043 i \\ 0.0030 - 0.0011 i\end{matrix} \} \qquad ( 8 )$$

Filling the force vector for the candidate tire {A}_{c} may be:

$${\{ A \}}_{c} = \{ \begin{matrix}- 7.1985 - 1.7128 i \\ - 16.9754 + 22.8143 i\end{matrix} \} \qquad ( 9 )$$

The predicted acceleration response spectrum {A}ₚ may be:

{A}ₚ={H}^{T}{A}^{T}={0.0088−0.0620i} (10)

The predicted magnitude of {A}ₚ may equal 0.0626. This result may be is very close to the measured acceleration spectrum line {A}ₘ:

{A}ₘ={0.0282+0.0536i} (11)

The measured magnitude of {A}ₘ may equal 0.0606. Thus, at 15 hz vibration excitation, the system 400 of FIG. 4 may predict a vibration magnitude within 3.4 percent of the measured vibration magnitude [(0.0626-0.06060)/0.0606=0.033<3.4 percent].

The present invention has been described with reference to example embodiments. Modifications and alterations may occur to others upon a reading and understanding of the specification. It is intended by the applicant to include all such modifications and alterations insofar as they come within the scope of the appended claims or the equivalents thereof.

What is claimed:

1. A system for predicting vibration or acoustic responses of a vehicle to a predetermined excitation of a candidate tire of the vehicle comprising:
a first accelerometer for measuring tire responses at a test rig to the predetermined excitation of a reference tire mounted on the rig;
a second accelerometer, microphone, or other vibration or acoustic sensor for measuring vibration and acoustic responses at a location on the vehicle to the predetermined excitation of the reference tire mounted on the vehicle;
a computer for calculating transfer functions as a ratio of the vibration or acoustic responses from the second accelerometer, microphone, or other vibration or acoustic sensor divided by the tire responses from the first accelerometer;
the computer predicting candidate tire responses, similar to the tire responses of the first accelerometer, of the reference tire mounted on the test rig; and
the computer predicting vehicle vibration or acoustic responses, similar to the vibration responses of the second accelerometer, of the candidate tire mounted on the vehicle by multiplying the predicted candidate tire responses by the transfer functions.

2. The system as set forth in claim 1 wherein the predetermined excitation is defined by a cleat fixed to a rotating drum.

3. The system as set forth in claim 1 wherein the computer compares the predicted vehicle vibration responses to the predetermined excitation of the candidate tire to expected vibration responses to the predetermined excitation of the candidate tire.

4. The system as set forth in claim 1 further including suspension parameters for predicting vibration responses of the reference tire on the test rig tire such that suspended test rig vibration responses equal vibration responses of the reference tire measured on the vehicle.

5. The system as set forth in claim 1 further including a third accelerometer for measuring vibration responses at a second location on the vehicle to the predetermined excitation of the reference tire mounted on the vehicle.

6. The system as set forth in claim 5 wherein the computer calculates transfer functions as a ratio of the vibration responses from the third accelerometer divided by the tire responses from the first accelerometer.

7. A method for predicting vibration response of a vehicle to a predetermined excitation of a candidate tire of the vehicle comprising the steps of:
measuring or predicting tire responses at a test rig to a predetermined excitation of a reference tire mounted on the test rig;
measuring vibration or acoustic responses at a location on the vehicle to the predetermined excitation of the reference tire mounted on the vehicle;
calculating transfer functions as a ratio of the vibration or acoustic responses on the vehicle divided by the tire vibration responses on the rig;
predicting vibration responses of the candidate tire mounted on the test rig; and
predicting vehicle vibration or acoustic responses for the candidate tire mounted on the vehicle by multiplying the predicted vibration responses by the transfer functions.

8. The method as set forth in claim 7 wherein the predetermined excitation is defined by a cleat fixed to a rotating drum.

9. The method as set forth in claim 7 further including the step of comparing the predicted vehicle vibration responses to the predetermined excitation of the candidate tire to expected vibration responses to the predetermined excitation of the candidate tire.

10. The method as set forth in claim 7 further including suspension parameters for predicting vibration responses of the reference tire on the test rig tire such that suspended test rig vibration responses equal vibration responses of the reference tire measured on the vehicle.

11. The method as set forth in claim 7 further including the step of measuring vibration responses at a second location on the vehicle to the predetermined excitation of the reference tire mounted on the vehicle.

12. The method as set forth in claim 11 further including the step of calculating transfer functions as a ratio of the vibration responses from the second location divided by the measured responses of the reference tire on the rig.

13. The method as set forth in claim 7 wherein the measured vibration responses on the test rig and vibration responses on the vehicle include a fore/aft component, a lateral component, and a vertical component.

14. The method as set forth in claim 13 wherein the predicted acceleration or vibration of the candidate tire and vibration responses of the vehicle include a fore/aft component, a lateral component, and a vertical component.

15. The method as set forth in claim 7 further including the step of measuring vibration responses at second and third locations on the vehicle to the predetermined excitation of the reference tire mounted on the vehicle.

16. The method as set forth in claim 15 further including the step of predicting vibration responses at second and third locations on the vehicle to the predetermined excitation of the candidate tire mounted on the vehicle.

17. The method as set forth in claim 16 wherein the measured vibration responses of the reference tire include a fore/aft component, a lateral component, and a vertical component.

18. The method as set forth in claim 17 wherein the predicted vibration responses of the candidate tire include a fore/aft component, a lateral component, and a vertical component.

19. A method for predicting vibration response of a vehicle to a predetermined excitation of a candidate tire on the vehicle comprising the steps of:
measuring or predicting tire responses at a spindle of a vehicle to the predetermined excitation of a reference tire mounted on the vehicle;
measuring vibration or acoustic responses at a location on the vehicle to the predetermined excitation of the reference tire mounted on the vehicle;
calculating transmissibility functions as a ratio of the vibration or acoustic responses of the vehicle divided by the tire responses measured or predicted on the spindle of the vehicle;
predicting spindle vibrations of the candidate tire mounted on the spindle; and
predicting vehicle vibration or acoustic responses for the candidate tire mounted on the vehicle by multiplying the predicted spindle vibration responses by the transmissibility functions.

20. The method as set forth in claim 19 further including the step of measuring vibration or acoustic responses at a second location of the vehicle to the predetermined excitation of the reference tire mounted on the vehicle.
